(19) United States
(12) Patent Application Publication
(10) Pub. No.: US 2026/0219112 A1
(43) Pub. Date: Jul. 30, 2026

(54) TEMPERATURE MEASUREMENT DEVICE FOR FOOD INGREDIENT

(71) Applicant: Shenzhen Typhur Technology Co., Ltd, Shenzhen (CN)

(72) Inventor: Zhanbin HUANG, Shenzhen (CN)

(21) Appl. No.: 19/157,361

(22) PCT Filed: Feb. 17, 2023
(86) PCT No.: PCT/CN2023/076964

§ 371 Date: Aug. 17, 2025

(51) Int. Cl. G01K 1/024; H01Q 1/22; H01Q 1/48

(52) U.S. Cl. CPC G01K 1/024; H01Q 1/22; H01Q 1/48; G01K 2207/02

(57) ABSTRACT

A temperature measurement device for food, including: a housing and a control circuit board; the housing forming a mounting chamber; the housing including a metal section and an insulating section, the insulating section is located behind the metal section; the control circuit board is defined in the mounting chamber; the control circuit board having a main portion and an extension portion extending rearward from the main portion, the main portion is defined in the mounting chamber formed by the metal section, the main portion having a control circuit, the control circuit having an antenna signal processing unit; the extension portion having at least one layer or multiple layers of stacked and fixed substrate layers, the extension portion being provided with an antenna, the antenna is electrically connected to the antenna signal processing unit through a conductive wire; the main portion of the control circuit board near the extension portion is also provided with a ground feed point, the ground feed point is electrically connected to the antenna signal processing unit, the ground feed point is in abutting connection with the metal section through a metal contact.

### TECHNICAL FIELD

This application relates to the field of food cooking, specifically to a temperature measurement device for detecting the temperature of food.

### BACKGROUND

With the advancement of technology and the increasing demands of people for the taste and nutritional requirements of food, people expect more precise control of temperature elements in the cooking process, such as more accurate control of the temperature of food.

In meat or other similar food, there is often a significant difference between the surface temperature and the internal temperature, especially the temperature at the center of the food is usually the lowest. In order to detect the temperature near the central area of the food, the temperature measurement device is usually designed as a structure that may be inserted into the food, such as a needle-like structure, so as to be inserted into the interior of the food to obtain the internal temperature of the food (such as the central area).

Usually, in order to continuously obtain the temperature of the food, during the cooking process of the food, the temperature measurement device remains inserted into the food and stays in the cooking space together with the food (such as an oven, steam box, fryer, etc.).

After the temperature measurement device obtains the temperature, it needs to wirelessly transmit the temperature signal to other devices. Considering the environment in which the temperature measurement device is configured and its own structure, how to design its antenna structure is a challenging problem.

### SUMMARY

To solve the above problems, this application mainly provides a temperature measurement device for food, which is specifically described below.

According to a first aspect, an embodiment provides a temperature measurement device for food, including:

A housing, the housing having a front end that is capable of being inserted into the food and a rear end opposite to the front end, the housing forming a mounting chamber; the housing including a metal section and an insulating section, the insulating section being located behind the metal section;

A control circuit board, the control circuit board is defined in the mounting chamber; the control circuit board comprising a main portion and an extension portion extending rearward from the main portion, the main portion is defined in the mounting chamber formed by the metal section, the main portion comprising a control circuit, the control circuit comprising an antenna signal processing unit; the extension portion comprising at least one layer or multiple layers of stacked and fixed substrate layers, the extension portion is provided with an antenna, the antenna is electrically connected to the antenna signal processing unit through a conductive wire; the main portion of the control circuit board near the extension portion is also provided with a ground feed point, the ground feed point being electrically connected to the antenna signal processing unit, the ground feed point is in abutting connection with the metal section through a metal contact.

In one embodiment, a substrate layer provided with the antenna is an antenna layer, and in a stacking direction of the substrate layers, the antenna layer is located at the outermost side.

In one embodiment, the substrate layers are at least two layers, and in the stacking direction of the substrate layers, the two substrate layers located at the outermost sides are both the antenna layers, and the antennas on the two antenna layers are electrically connected to each other.

In one embodiment, one antenna layer is a first antenna layer, and the other antenna layer is a second antenna layer; on the first antenna layer, its antenna is electrically connected to the antenna signal processing unit through the conductive wire.

In one embodiment, the first antenna layer is provided with a first impedance matching structure, the first impedance matching structure is defined on two sides of the conductive wire;

The first impedance matching structure extends forward to the ground feed point of the main portion, so that the first impedance matching structure is electrically connected to the ground feed point.

In one embodiment, a distance between the first impedance matching structure and the conductive wire is 5 mil.

In one embodiment, a width of the conductive wire is 17 mil.

In one embodiment, the main portion of the control circuit board near the extension portion is provided with two ground conductive vias to form the ground feed point.

In one embodiment, the metal contact includes an elastic member, two ends of the elastic member are respectively connected to the two ground conductive vias, and forming an arch shape to be in abutting connection with the metal section.

In one embodiment, the elastic member is a spring.

In one embodiment, the metal contact includes a spring, two ends of the spring are respectively connected to the two ground conductive vias and in contact with the metal section.

In one embodiment, the substrate layers have six layers.

In one embodiment, the first antenna layer is adjacent to two clearance layers.

In one embodiment, the first antenna layer is the first layer, and the fourth layer among the substrate layers is set as a complete ground plane.

In one embodiment, the complete ground plane is electrically connected to the first impedance matching structure through a second conductive via.

In one embodiment, the second antenna layer is provided with a second impedance matching structure, the second impedance matching structure corresponding in position to the first impedance matching structure, and being electrically connected to the first impedance matching structure through a second conductive via.

In one embodiment, the temperature measurement device further includes an ambient temperature detection unit, the ambient temperature detection unit is defined on the housing for detecting the temperature of the cooking environment of the food;

The extension portion is also provided with an onboard conductive wire, the antenna and the onboard conductive wire are respectively fixed on different substrate layers, the onboard conductive wire is configured to electrically connect the control circuit to the ambient temperature detection unit.

In one embodiment, the substrate layers are at least three layers, and in the stacking direction of the substrate layers, the two substrate layers located at the outermost sides are both the antenna layers, and the antennas on the two antenna layers are electrically connected to each other;

The substrate layer provided with the onboard conductive wire is located between the two antenna layers.

In one embodiment, the control circuit board near the extension portion is provided with two conductive vias to form the ground feed point.

In one embodiment, the onboard conductive wire has a detection unit positive wire and a detection unit negative wire, the first detection unit wire and the second detection unit wire electrically connecting the ambient temperature detection unit to the control unit, a substrate layer where the first detection unit wire and the second detection unit wire are located is located inside the antenna layer, the antenna layer having a first contact and a second contact for electrically connecting the ambient temperature detection unit, the first contact is electrically connected to the detection unit positive wire, the second contact is electrically connected to the detection unit negative wire.

In one embodiment, the first detection unit wire and the second detection unit wire are fixed on the same substrate layer or respectively fixed on different substrate layers, the first detection unit wire is electrically connected to the first contact through a third conductive via, the second detection unit wire is electrically connected to the second contact through a fourth conductive via.

In one embodiment, the onboard conductive wire has a charging wire, the control circuit has a charging circuit, the charging wire is electrically connected to the charging circuit; a substrate layer provided with the charging wire is a charging wire layer, the charging wire layer is located inside the antenna layer, the antenna layer comprising a charging contact, the charging contact is electrically connected to the charging wire.

In one embodiment, the insulating section is provided with a metal conductive member, the metal conductive member is electrically connected to the charging contact, the metal section is electrically connected to the charging circuit, the metal conductive member and the metal section respectively serving as one of the positive electrode and negative electrode of the charging circuit to achieve charging.

In one embodiment, the charging wire layer is located between the antenna layer and the first detection unit wire layer, or located between the antenna layer and the second detection unit wire layer, the charging contact is electrically connected to the charging wire through a fifth conductive hole.

In one embodiment, a substrate layer adjacent to the antenna layer is a clearance layer.

In one embodiment, the clearance layer has two layers.

In one embodiment, the lateral dimension of the extension portion is smaller than the lateral dimension of the main portion.

According to the temperature measurement device of some of the above embodiments, an antenna with a dipole structure is constructed, and a ground plane is constructed near the antenna signal feed point, providing a loop, thereby making the signal attenuation very small.

### BRIEF DESCRIPTION OF THE DRAWINGS

FIG. 1 is a schematic diagram of the appearance structure of the temperature measurement device in one embodiment of this application;

FIG. 2 is an exploded schematic diagram of the temperature measurement device in one embodiment of this application;

FIG. 3 is an exploded schematic diagram of the control circuit board, ambient temperature detection unit, and metal conductive member in one embodiment of this application;

FIG. 4 is a schematic diagram of the structure of the control circuit board in one embodiment of this application;

FIG. 5 is a cross-sectional schematic diagram of the housing, control circuit board, ambient temperature detection unit, and metal conductive member in one embodiment of this application;

FIG. 6 is a schematic diagram of the stacked structure of each substrate layer of the extension portion of the control circuit board in one embodiment of this application;

FIG. 7 is a schematic diagram of the circuits on each substrate layer of the extension portion in one embodiment of this application, where the substrate layers are omitted, and the circuits of each substrate layer are shown in the same plane to facilitate the overall electrical connection situation of the antenna and the onboard conductive wire;

FIG. 8 is a schematic diagram of the circuit on the first antenna layer in one embodiment of this application;

FIG. 9 is a schematic diagram of the circuit on the clearance layer in one embodiment of this application;

FIG. 10 is a schematic diagram of the circuit on the first detection unit wire layer in one embodiment of this application;

FIG. 11 is a schematic diagram of the circuit on the second detection unit wire layer in one embodiment of this application;

FIG. 12 is a schematic diagram of the circuit on the charging wire layer in one embodiment of this application;

FIG. 13 is a schematic diagram of the circuit on the second antenna layer in one embodiment of this application;

FIG. 14 is a schematic diagram of the electrical connection of the antenna signal processing unit and charging circuit in the control circuit with other structures in one embodiment of this application;

FIG. 15 is a schematic diagram of the structure of the metal contact in one embodiment of this application.

### DETAILED DESCRIPTION OF THE EMBODIMENTS

The following provides a further detailed description of this application through specific embodiments in conjunction with the drawings. Similar elements in different embodiments are assigned associated similar element numbers. In the following embodiments, many detailed descriptions are provided to enable a well understanding of this application. However, those skilled in the art may easily recognize that some features may be omitted in different situations, or may be replaced by other elements, materials, or methods. In some cases, some operations related to this application are not shown or described in the specification, this is to avoid overwhelming the core part of this application with excessive descriptions, and for those skilled in the art, a detailed description of these related operations is not necessary; they may fully understand the related operations based on the description in the specification and general technical knowledge in the field.

In addition, the features, operations, or characteristics described in the specification may be combined in any appropriate manner to form various embodiments. At the same time, the steps or actions in the method description may also be sequentially exchanged or adjusted in a manner obvious to those skilled in the art. Therefore, the various sequences in the specification and drawings are only for clearly describing a certain embodiment and do not imply a necessary sequence unless otherwise specified that a certain sequence must be followed.

The numbering of components herein, such as “first,” “second,” etc., is only configured to distinguish the described objects and does not have any sequential or technical meaning. The terms “connection” and “coupling” in this application, unless otherwise specified, include both direct and indirect connections (couplings).

This application provides a temperature measurement device for food, which may be inserted into the interior of the food during the cooking process to detect the internal temperature of the food, especially to obtain the lowest internal temperature of the food as accurately as possible. The food may be in any cooking state, and any cooking state includes but is not limited to: steaming, boiling, baking, roasting, frying, deep-frying, etc., or heat treatment by any other means. In some embodiments, the temperature measurement device may be directly placed in the measured environment for temperature measurement. The measured environment includes but is not limited to: cooking environment, etc.

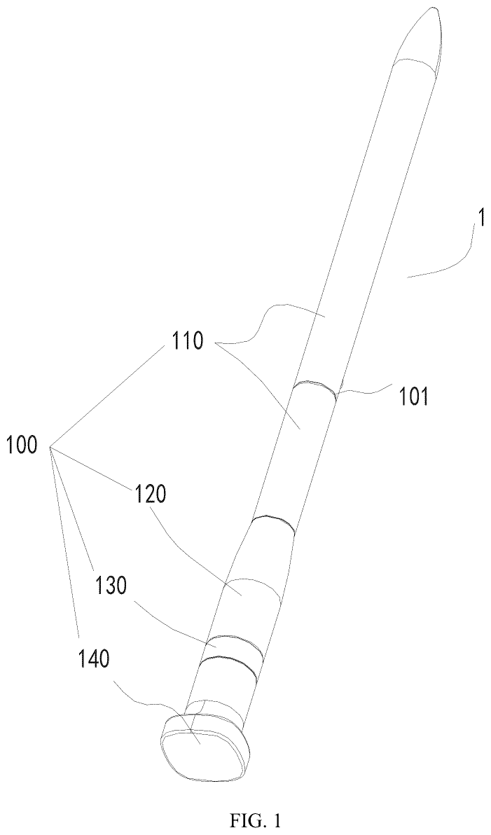

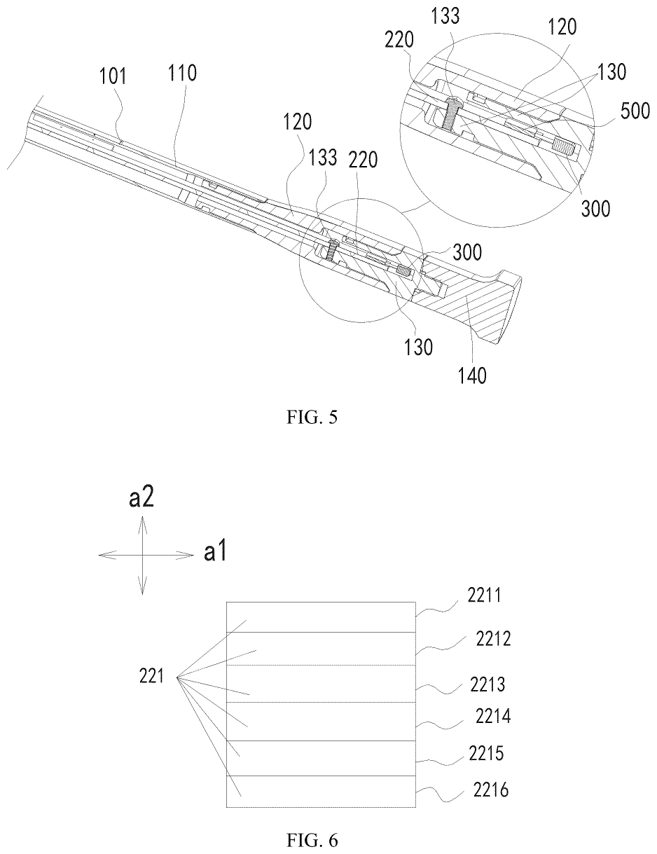

Please refer to FIGS. 1-5, the temperature measurement device 1 includes a housing 100 and a control circuit board 200. In some embodiments, the temperature measurement device 1 may also include other related components according to other functional needs, such as an ambient temperature detection unit 300, or for example, a food temperature detection unit 400 for detecting the temperature of the food, or for example, a battery for power supply, etc.

The housing 100 is configured to protect and install components that realize the functions of the temperature measurement device 1 (such as the food temperature detection unit 400, control circuit board 200, battery, and/or ambient temperature detection unit 300, etc.). The housing 100 forms a mounting chamber to accommodate and install other components. In some embodiments, the housing 100 may be a structure with an internal cavity, and the functional components of the temperature measurement device 1 may be defined in the internal cavity of the housing 100. In some embodiments, the internal cavity of the housing 100 may be one, and the functional components of the temperature measurement device 1 may be defined in the cavity; the internal cavities of the housing 100 may also be multiple, and each cavity may be provided with one or more functional components of the temperature measurement device 1. One or more cavities may be in any shape, as long as they do not affect the installation of the functional components of the temperature measurement device 1.

Please refer to FIGS. 1-5, in some embodiments, the housing 100 may be assembled from multiple parts. In other embodiments, the housing 100 may also be formed from one part.

In some embodiments, the housing 100 may wrap the functional components of the temperature measurement device 1, that is, the housing 100 may be located at the outermost layer of the temperature measurement device 1, blocking contact between the outside world and the components inside the housing 100. In some embodiments, the housing 100 may not completely wrap the functional components of the temperature measurement device 1, for example, part of the ambient temperature detection unit 300 may be located outside the housing 100 to facilitate temperature measurement.

Please refer to FIGS. 1-5, in some embodiments, the housing 100 has a front end that may be inserted into the food and a rear end opposite to the front end. For example, the end of the housing 100 with a pointed protrusion is the front end, and using the pointed protrusion, the temperature measurement device 1 may be easily inserted into the measured object for temperature measurement. In some embodiments, the housing 100 may be formed as a long strip structure, for example, a tubular structure. In some embodiments, the diameter of the front end of the long strip structure of the housing 100 gradually decreases until it approaches 0, forming a closed sharp front end. In some embodiments, the housing 100 may be a hollow tubular structure with one end closed, and the functional components of the temperature measurement device 1 may be installed inside the hollow tubular structure. In some embodiments, the cross-section of the housing 100 may be circular, elliptical, triangular, rectangular, polygonal, or irregular shape. In some embodiments, to facilitate holding the temperature measurement device 1 for temperature measurement, one end of the housing 100 (such as the rear end) may be provided with a handle portion that is easy to grip, and in some embodiments, the handle portion may be set away from the front end. In some embodiments, the material of the housing 100 may have a certain hardness to maintain the shape of the housing 100 and provide certain protection for the internal functional components.

The control circuit board 200 is defined in the mounting chamber of the housing 100, and it may be directly or indirectly fixed on the housing 100. The control circuit board 200 has a control circuit 211, which is configured to control some or all functions of the temperature measurement device 1, such as but not limited to controlling each sensor, receiving, processing, and sending temperature signals, communication control with other devices, and/or charging of the device, etc. The control circuit 211 may adopt various circuits and/or structures capable of realizing information processing and logical judgment, such as devices with processors, memories, etc.

The ambient temperature detection unit 300 is electrically connected to the control circuit 211, and the ambient temperature detection unit 300 is configured to detect the temperature of the measured environment (such as the cooking environment). The food temperature detection unit 400 is electrically connected to the control circuit 211, and the food temperature detection unit 400 is configured to detect the temperature of the food. The measured ambient temperature may be configured to help but not limited to the control circuit 211 to well judge the true temperature of the food, etc., which may be achieved through existing technology and will not be repeated here. The ambient temperature detection unit 300 is defined on the housing 100, and it may be completely built into the housing 100 or partially exposed from the housing 100 to detect the temperature of the cooking environment. The food temperature detection unit 400 and the ambient temperature detection unit 300 have structures capable of directly or indirectly detecting temperature, and they may adopt any feasible scheme to realize temperature detection. For example, in some embodiments, the food temperature detection unit 400 and the ambient temperature detection unit 300 have elements for sensing heat to obtain temperature information. In some embodiments, the food temperature detection unit 400 and the ambient temperature detection unit 300 may detect temperature or temperature-related signals and convert them into usable output signals as sensors.

In some embodiments, the sensor may be a thermocouple (TC), resistance temperature detector (RTD), thermistor, etc., or any combination thereof. In some embodiments, to make the temperature measurement fast, the sensor may be a thermocouple. The thermocouple is formed by joining two conductors of different compositions at both ends into a loop, where the end directly configured for measuring temperature is the measuring end, and the other end is the compensation end. In some embodiments, the sensor may be a negative temperature coefficient (NTC) type thermistor. The thermistor comprises a thermal probe (measuring end), conductive connection end, and housing 100.

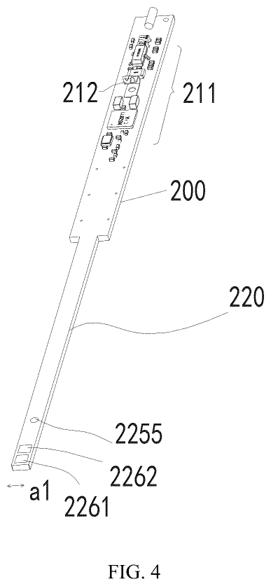

Please refer to FIG. 4, in some embodiments, the control circuit board 200 has a main portion 210 and an extension portion 220 extending rearward from the main portion 210. The main portion 210 and the extension portion 220 form an integrated structure, which includes the two being fixedly connected to each other (such as welding, bonding, snapping, screw fixing, etc.), and also includes the two being integrally manufactured as a whole structure (that is, the main portion 210 and the extension portion 220 are different areas of the same circuit board).

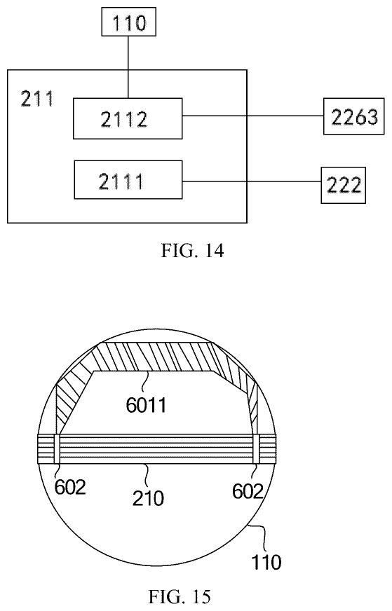

The control circuit 211 is defined on the main portion 210, and the control circuit 211 may serve as the main control part of the entire control circuit board 200. For example, in some embodiments, please refer to FIG. 14, the control circuit 211 may have an antenna signal processing unit 2111, etc., to realize data processing and instruction sending. The antenna signal processing unit 2111 may be configured to control the signal transmission and reception of the antenna and to process the antenna signals, etc.

In some embodiments, the extension portion 220 has one substrate layer 221; in some embodiments, the extension portion 220 has at least two stacked and fixed substrate layers 221. Please refer to FIGS. 4 and 6, in some embodiments, the extension portion 220 has at least two stacked and fixed substrate layers 221. Each substrate layer 221 is configured to set corresponding circuits. The substrate layer 221 is made of insulating material, for example, in some embodiments, various materials that may be configured as circuit board substrates may be selected. In some embodiments, the main portion 210 may also be made of the same material as the extension portion 220 to form the final main portion 210. In some embodiments, the main portion 210 may adopt the same stacked structure of substrate layers 221 as the extension portion 220. The same layer of substrate layer 221 corresponding to each other on the main portion 210 and the extension portion 220 may be the same complete substrate, that is, using at least two substrate layers 221 stacked to form the entire control circuit board 200, and the control circuit board 200 is divided into the main portion 210 and the extension portion 220 according to different circuit structures in each area. In some embodiments, the main portion 210 and the extension portion 220 may also be two separate components, manufactured separately. The main portion 210 may not have the same stacked structure as the extension portion 220. In some embodiments, the control circuit 211 of the main portion 210 may be set on the same substrate layer 221, as long as the control circuit 211 on the main portion 210 may complete the related functions, such as realizing the signal transmission and reception of the antenna, detection of ambient temperature, device charging, etc. The structure of the main portion 210 may adopt any feasible scheme.

In some embodiments, the extension portion 220 is provided with an antenna 222. The antenna 222 is electrically connected to the antenna signal processing unit 2111. The antenna 222 is fixed on the extension portion 220, ensuring the position stability of the antenna 222.

In some embodiments, the extension portion 220 is also provided with the onboard conductive wire 223; the onboard conductive wire 223 refers to a conductive line fixed on the extension portion 220 of this onboard structure, and the conductive line is configured to electrically connect the control circuit 211 to other components, and other components may be, for example, but not limited to, the ambient temperature detection unit 300 and/or charging electrode, etc. The onboard conductive wire 223 is fixed on the extension portion 220, ensuring the position stability of the onboard conductive wire 223.

In the embodiments where the extension portion 220 is provided with the antenna 222 and the onboard conductive wire 223, the antenna 222 and the onboard conductive wire 223 are fixed on the extension portion 220, which not only ensures the position stability of the antenna 222 but also ensures the position stability of the onboard conductive wire 223, keeping the antenna 222 and the onboard conductive wire 223 in fixed relative positions, improving the consistency of the positions of the antenna 222 and the onboard conductive wire 223, avoiding shaking of the antenna 222 and the onboard conductive wire 223, thereby reducing interference to the communication signal of the antenna 222 caconfigured by shaking of the antenna 222 and the onboard conductive wire 223, and improving the communication effect of the antenna 222.

At the same time, compared to setting the antenna 222 and the onboard conductive wire 223 on the same substrate layer 221, in some embodiments, the antenna 222 and the onboard conductive wire 223 are further fixed on different substrate layers 221, making full use of the space in the stacking direction of the substrate layers 221 (as shown by a2 in FIG. 6), which may not only increase the distance between the antenna 222 and the onboard conductive wire 223, improving the communication effect of the antenna 222, but also reduce the width dimension of the substrate layer 221 (as shown by a1 in FIGS. 4 and 6), and the width of the entire extension portion 220 may be further reduced, leaving more space for other components in the temperature measurement device 1, which is beneficial for reducing the size of the entire temperature measurement device 1 in the width direction.

In some embodiments, the antenna 222 and the onboard conductive wire 223 may also be set on the same substrate layer 221, which may reduce the thickness of the extension portion 220 and the difficulty of processing and manufacturing. For example, in some embodiments, the extension portion 220 has one substrate layer 221, and the antenna 222 and the onboard conductive wire 223 are fixed on one side or both sides of the substrate layer 221.

To achieve fixing the antenna 222 and the onboard conductive wire 223 on the substrate layer 221, in some embodiments, the antenna 222 and the onboard conductive wire 223 are attached to the surface of the substrate layer 221. In some embodiments, the antenna 222 and the onboard conductive wire 223 may be fixed on the surface of the substrate layer 221 through printing or spraying processes, thereby attaching the antenna 222 and the onboard conductive wire 223 to the surface of the substrate layer 221. In some embodiments, other feasible methods may also be configured to fix the antenna 222 and the onboard conductive wire 223 on the surface of the substrate layer 221.

Further, when the antenna 222 and the onboard conductive wire 223 are set on different substrate layers 221, in specific stacking settings, the antenna 222 and the onboard conductive wire 223 may be set on any different layers of substrate layers 221. The antenna 222 may be set on the outermost substrate layer 221 or on the middle substrate layer 221. Similarly, the onboard conductive wire 223 may also be set on the outermost substrate layer 221 or the middle substrate layer 221. The onboard conductive wire 223 may be one or more types depending on the connected object, for example, it may be one or two of the charging wire and the wire of the ambient temperature detection unit. When there are two or more types of onboard conductive wires 223, these different types of onboard conductive wires 223 may be partially or fully set on the same substrate layer 221, or different types of onboard conductive wires 223 may each be independently dispersed on different substrate layers 221.

Please refer to FIGS. 6, 8, and 13, in some embodiments, the substrate layer 221 provided with the antenna 222 is an antenna layer (such as 2211, 2216), and in the stacking direction of the substrate layers 221, the antenna layer is located at the outermost side. As shown in FIG. 6, the outermost side may be the uppermost side in the illustrated direction (such as 2211) or the lowermost side in the illustrated direction (such as 2216). When the antenna layer is set at the outermost side, it may well ensure that the antenna 222 may transmit and receive signals more efficiently.

In some embodiments, when the antenna layer is located at the outermost side, the onboard conductive wire 223 may be set on one or more substrate layers 221 inside the antenna layer. When the antenna layer is one of the outermost substrate layers (such as the uppermost substrate layer 221 in FIG. 6), the onboard conductive wire 223 may be set on the other outermost substrate layer (such as the lowermost substrate layer 221 in FIG. 6).

In some embodiments, in some embodiments, the onboard conductive wire 223 may also be set on the antenna layer.

Further, please refer to FIGS. 6, 8, and 13, in some embodiments, the substrate layers 221 are at least three layers, and in the stacking direction of the substrate layers 221, the two substrate layers 221 located at the outermost sides are both antenna layers (such as 2211, 2216), and the antennas 222 on the two antenna layers (such as 2211, 2216) are electrically connected to each other. The advantage of setting two antenna layers is that, without changing the width of the substrate layer 221 and the extension portion 220 (as shown by a1 in FIGS. 4 and 6), using the space in the stacking direction (as shown by a2 in FIG. 6), the area of the antenna 222 may be increased, thereby improving the ability of the antenna 222 to transmit and receive signals and the communication effect. In other embodiments, more substrate layers 221 may also be set as antenna layers, such as using one or more middle substrate layers 221 as antenna layers.

Further, please refer to FIGS. 8 and 13, in some embodiments, to further increase the area of the antenna 222 and thereby improve the communication effect, the antenna 222 may be set as a planar antenna, with one end being a circular arc surface to facilitate signal conduction and radiation. In some embodiments, the antenna 222 may also be set as other planar structures besides those in FIGS. 8 and 13, or set as other shapes and structures capable of realizing wireless signal transmission and reception.

Further, please refer to FIGS. 6 and 8-13, to achieve conductive connection of two or more antenna layers in the stacking direction, in some embodiments, the antenna layers (such as 2211, 2216) and the substrate layer 221 between the two antenna layers (such as 2211, 2216) are provided with first conductive vias 2251, and the first conductive vias 2251 are conductively connected to each other, electrically connecting the antennas 222 on the two antenna layers (such as 2211, 2216). Specifically, the first conductive vias 2251 on each substrate layer 221 are set through the substrate layer 221, and the hole walls of the first conductive vias 2251 are provided with conductive material. After the substrate layers 221 are stacked, the first conductive vias 2251 of adjacent substrate layers 221 may be sequentially conductively connected.

In some embodiments, the antenna layers may also be electrically connected in other ways, such as through cable electrical connection, etc.

Further, please refer to FIGS. 6, 8, 13, and 14, in some embodiments, one antenna layer is the first antenna layer 2211, and the other antenna layer is the second antenna layer 2216. The first antenna layer 2211 may be either the top layer as shown in FIG. 6 or the bottom layer as shown in FIG. 6. On the first antenna layer 2211, its antenna 222 is electrically connected to the antenna signal processing unit 2111 through the conductive wire 2221. Through the conductive wire 2221 and the first antenna layer 2211, the antenna 222 on the second antenna layer 2216 may also be electrically connected to the antenna signal processing unit 2111.

Please refer to FIG. 8, in some embodiments, to facilitate well transmission of the signal of the antenna 222 in a set direction, the first antenna layer 2211 is provided with a first impedance matching structure 2241, and the first impedance matching structure 2241 is defined on both sides of the conductive wire. The first impedance matching structure 2241 may help transmit the signal of the antenna 222 to a set direction, such as transmitting to the rear end of the housing 100, etc. Please refer to FIG. 13, in some embodiments, to well constrain the transmission of the signal of the antenna 222, when there is a second antenna layer 2216, the second antenna layer 2216 is provided with a second impedance matching structure 2242, and the second impedance matching structure 2242 corresponds in position to the first impedance matching structure 2241, for example, on a plane perpendicular to the stacking direction of the substrate layers 221 (as shown by a2 in FIG. 6), the projection of the second impedance matching structure 2242 partially overlaps or completely overlaps with the first impedance matching structure 2241. The second impedance matching structure 2242 may be electrically connected to the first impedance matching structure 2241 through a second conductive via 2252.

Further, please refer to FIGS. 6 and 8-13, in some embodiments, the substrate layer 221 provided with the onboard conductive wire 223 is located between the two antenna layers (such as 2211, 2216) to facilitate using the outermost substrate layers 221 as antenna layers. These substrate layers 221 where the onboard conductive wires 223 are located may be provided with first conductive vias 2251 to achieve conductive connection of the antenna layers.

Please refer to FIGS. 6 and 8-13, in some embodiments, the onboard conductive wire 223 has a first detection unit wire 2231 and a second detection unit wire 2232 (i.e., wires for the ambient temperature detection unit). The first detection unit wire 2231 and the second detection unit wire 2232 electrically connect the ambient temperature detection unit 300 to the control circuit 211. The substrate layers 221 where the first detection unit wire 2231 and the second detection unit wire 2232 are located are located inside the antenna layer, and the antenna layer has a first contact 2261 and a second contact 2262 for electrically connecting the ambient temperature detection unit 300. As shown in FIG. 8, in one embodiment, the first contact 2261 and the second contact 2262 are defined on the first antenna layer 2211. In other embodiments, the first contact 2261 and the second contact 2262 may also be defined on the second antenna layer 2216. The first contact 2261 is electrically connected to the first detection unit wire 2231, and the second contact 2262 is electrically connected to the second detection unit wire 2232.

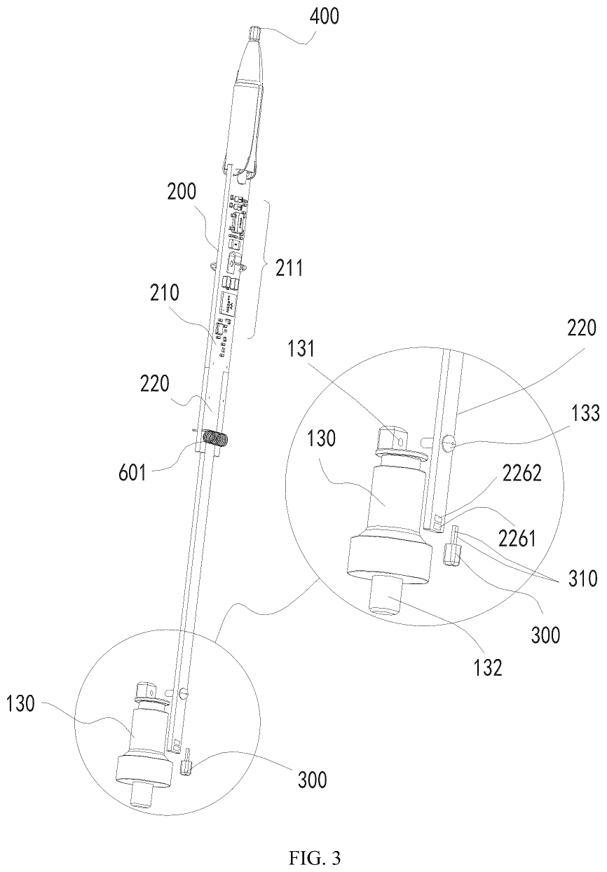

Please refer to FIGS. 3 and 8, in some embodiments, the ambient temperature detection unit 300 may be electrically connected to the first contact 2261 and the second contact 2262 on the first antenna layer 2211, for example, by welding or other fixing methods to achieve electrical connection between the conductive connection end of the ambient temperature detection unit 300 and the first contact 2261 and the second contact 2262.

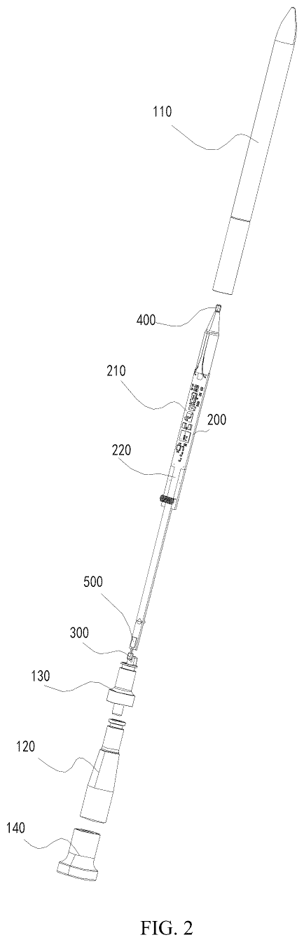

Please refer to FIGS. 2-5, in some embodiments, the conductive connection end 310 of the ambient temperature detection unit 300 is welded and fixed and electrically connected to the first contact 2261 and the second contact 2262 (collectively referred to as conductive contacts). Considering that during the use of this device, the solder joints between the conductive connection end 310 of the ambient temperature detection unit 300 and the first contact 2261 and the second contact 2262 are located in the cooking environment and need to withstand the high temperature test in the cooking environment. Materials usually configured for circuit welding are prone to melting at high temperatures, leading to electrical connection failure, such as when the cooking environment is higher than 300° C., the electrical connection between the conductive connection end 310 of the ambient temperature detection unit 300 and the first contact 2261 and the second contact 2262 is prone to detachment and failure. Therefore, in some embodiments, the solder joints between the conductive connection end 310 and the first contact 2261 and the second contact 2262 are wrapped by an adhesive layer 500, and the failure temperature of the adhesive layer 500 is higher than the failure temperature of the solder joints between the conductive connection end 310 and the first contact 2261 and the second contact 2262, thereby preventing the solder joints from being damaged in a high-temperature environment and ensuring the reliability of the electrical connection.

In some embodiments, the material of the adhesive layer 500 is high-temperature inorganic adhesive or high-temperature organic adhesive.

In some embodiments, the failure temperature threshold of the high-temperature organic adhesive is greater than or equal to 300° C.

In some embodiments, the failure temperature threshold of the high-temperature inorganic adhesive is greater than or equal to 400° C.

Further, please refer to FIGS. 8-13, in some embodiments, the first detection unit wire 2231 and the second detection unit wire 2232 are respectively fixed on different substrate layers 221. The first detection unit wire 2231 is electrically connected to the first contact 2261 through a third conductive via 2253, and the second detection unit wire 2232 is electrically connected to the second contact 2262 through a fourth conductive via 2254. In some embodiments, the first detection unit wire 2231 and the second detection unit wire 2232 may also be fixed on the same substrate layer 221.

FIG. 11 shows the routing of the first detection unit wire 2231 on the substrate layer 221. FIG. 12 shows the routing of the second detection unit wire 2232 on the substrate layer 221. In other embodiments, the onboard conductive wire 223 shown in FIG. 11 may also be set as the second detection unit wire 2232, and the onboard conductive wire 223 shown in FIG. 12 may be set as the first detection unit wire 2231.

In some embodiments, the substrate layer 221 provided with the first detection unit wire 2231 is called the first detection unit wire layer 2214, and the substrate layer 221 provided with the second detection unit wire 2232 is called the second detection unit wire layer 2215. As shown in FIG. 6, in some embodiments, the first detection unit wire layer 2214 and the second detection unit wire layer 2215 are different substrate layers 221 and are stacked with each other.

To well constrain the transmission of the signal of the antenna 222, in some embodiments, please refer to FIG. 11, the first detection unit wire layer 2214 has a third impedance matching structure 2243, and the third impedance matching structure 2243 is defined on both sides of the first detection unit wire 2231. And/or, please refer to FIG. 12, the second detection unit wire layer 2215 has a fourth impedance matching structure 2244, and the fourth impedance matching structure 2244 is defined on both sides of the second detection unit wire 2232. Among them, the third impedance matching structure 2243 and the fourth impedance matching structure 2244 are electrically connected to the second impedance matching structure 2242 and the first impedance matching structure 2241 through the second conductive via 2252, thereby forming an overall impedance matching structure on the multi-layer substrate layers 221, well constraining the transmission direction of the signal of the antenna 222.

Further, the onboard conductive wire 223 may also be a conductive wire for other purposes, for example, when the device has charging needs, the onboard conductive wire 223 may also have a charging wire. Please refer to FIG. 14, the control circuit 211 has a charging circuit 2112, and the charging wire 2233 may be one or two, the purpose is to electrically connect at least one of the charging positive electrode and charging negative electrode configured to achieve charging to the charging circuit 2112 to achieve the charging purpose.

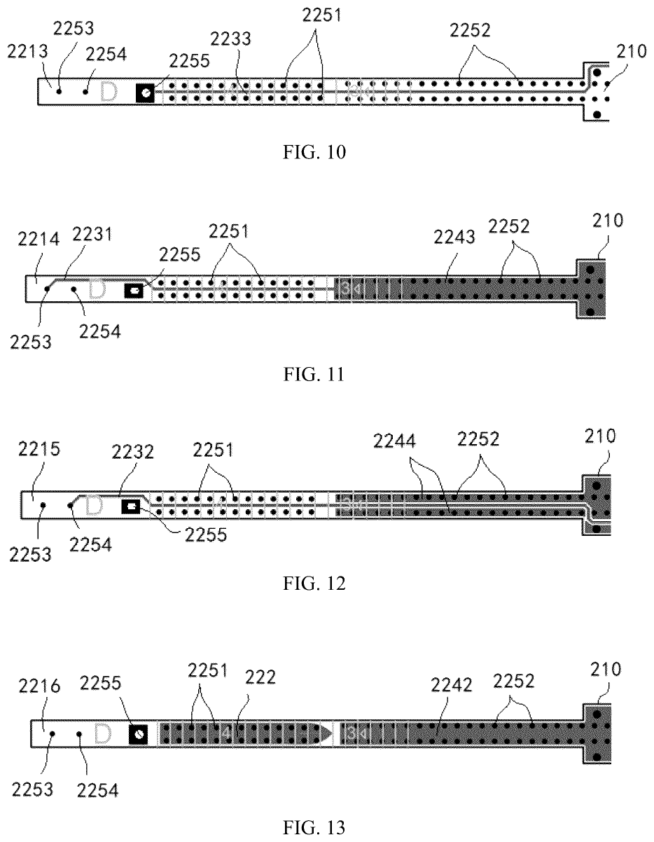

Please refer to FIGS. 6 and 10, in some embodiments, the substrate layer 221 provided with the charging wire 2233 is called the charging wire layer 2213, and the charging wire layer 2213 is located inside the antenna layer. The antenna layer has at least one charging connection end 2263. As shown in FIG. 8, in one embodiment, the charging connection end 2263 is defined on the first antenna layer 2211. In other embodiments, the charging connection end 2263 may also be defined on the second antenna layer 2216. The charging connection end 2263 is electrically connected to the charging wire 2233, and the charging connection end 2263 may be configured to achieve electrical connection with at least one of the charging positive electrode and charging negative electrode, for example, electrically connected to the metal conductive member 130 introduced later. The charging connection end 2263 has a conductive structure, for example, it may be a conductive contact or other structure.

Please refer to FIGS. 2-5, in some embodiments, to form charging positive and negative electrodes convenient for charging, the housing 100 includes a metal section 110 and an insulating section 120. The metal section 110 and the insulating section 120 are both tubular structures, and the insulating section 120 may be docked at the rear end of the metal section 110. The metal section 110 and the insulating section 120 may be configured to jointly enclose at least part of the accommodation cavity of the housing 100. The metal section 110 may be made of metal materials such as copper, nickel, or alloy materials such as stainless steel. The insulating section 120 may be made of ceramic or other insulating materials. The insulating section 120 is provided with a metal conductive member 130, and the metal conductive member 130 is electrically connected to the charging connection end 2263. The metal section 110 is electrically connected to the charging circuit 2112. Among them, the metal conductive member 130 and the metal section 110 respectively serve as one of the charging positive electrode and charging negative electrode of the charging circuit 2112, for example, the metal conductive member 130 as the charging positive electrode and the metal section 110 as the charging negative electrode, or the metal conductive member 130 as the charging negative electrode and the metal section 110 as the charging positive electrode, to achieve charging.

Please refer to FIGS. 2-5, in some embodiments, the control circuit board 200 is provided with an elastic pogo pin 212, the elastic pogo pin 212 is made of conductive material, one end of which is kept electrically connected to the charging circuit 2112, and the other end is kept electrically connected to the inner wall of the metal section 110, thereby electrically connecting the metal section 110 of the housing 100 to the charging circuit 2112. In some embodiments, the elastic pogo pin 212 may also be replaced by other materials, such as conductive springs, etc. The elastic pogo pin 212 serves as a charging electrode and is also configured for positioning and limiting the control circuit board 200 in the accommodation cavity, reducing the shaking of the control circuit board 200 in the accommodation cavity.

Please refer to FIGS. 2-5, in some embodiments, the metal conductive member 130 is exposed from the insulating section 120, wherein the metal conductive member 130 extends to the charging connection end 2263 of the antenna layer and is electrically connected to the charging connection end 2263, and then electrically connected to the charging circuit 2112 through the charging wire 2233. The metal conductive member 130 may be fixed to the charging connection end 2263 by welding, snapping, bonding, etc., and maintain electrical connection.

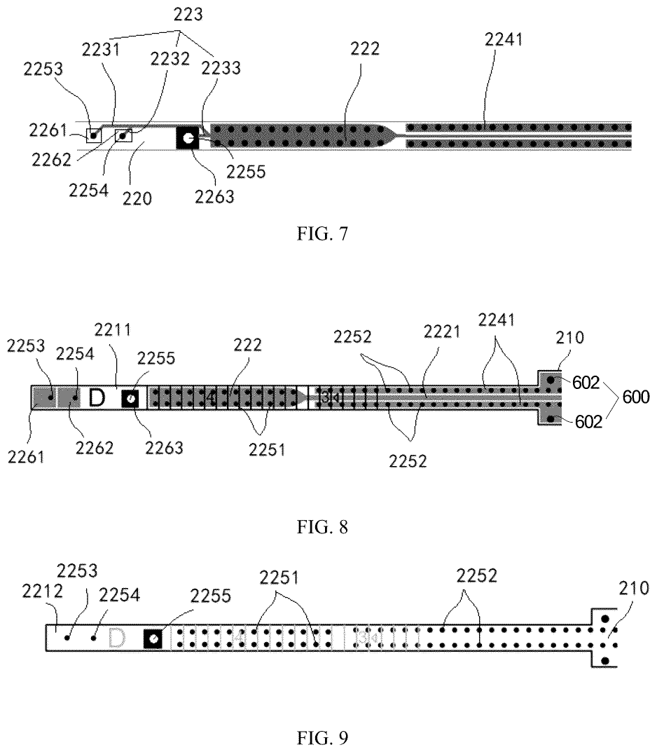

During the use of this device, when the device is inserted into the food, the area where the insulating section 120 is located is usually outside the food and needs to withstand the high temperature test in the cooking environment. In some cooking environments, the temperature in the space may even reach above 300° C. For example, the cooking environment temperature in an oven may reach above 200° C., and the cooking environment temperature in a BBQ grill may reach above 500° C. To ensure reliable electrical connection between the metal conductive member 130 and the charging connection end 2263, in some embodiments, please refer to FIGS. 2-5 and FIGS. 7 and 8, the charging connection end 2263 has a fifth conductive via 2255, the metal conductive member 130 has a mounting hole 131, and the charging connection end 2263 and the metal conductive member 130 are fixed and electrically connected by a conductive screw 133 passing through the fifth conductive via 2255 and the mounting hole 131. The conductive screw 133 not only achieves locking and fixing of the charging connection end 2263 and the metal conductive member 130 but also plays a conductive role. The conductive screw 133 itself may withstand high temperatures, so this connection structure is not only firm and reliable, but its electrical connection effect may also withstand high temperature tests, for example, at 300° C., the conductive screw 133 may still ensure good electrical connection between the charging connection end 2263 and the metal conductive member 130.

Please refer to FIGS. 2-5, in some embodiments, the metal conductive member 130 extends from the rear end into the rear end of the insulating section 120. Since the metal conductive member 130 is made of conductive metal, it has good thermal conductivity. Therefore, in these embodiments, the ambient temperature detection unit 300 is at least partially set in the metal conductive member 130, using the metal conductive member 130 for heat transfer to achieve temperature detection. The metal conductive member 130 may be directly exposed in the cooking environment to well sense and transfer temperature information in the cooking environment. In some embodiments, the metal conductive member 130 may also indirectly contact the hot air in the cooking environment to form a heat conduction structure.

Please refer to FIGS. 2-5, in some embodiments, the metal conductive member 130 has an inner cavity, and the rear end of the extension portion 220 extends into the inner cavity, which facilitates the docking of the ambient temperature detection unit 300 with the extension portion 220 and also uses the good strength of the metal to protect the ambient temperature detection unit 300 placed in the metal conductive member 130.

Please refer to FIGS. 2-5, in some embodiments, the metal conductive member 130 is also part of the housing 100, and its outer wall forms the outer wall of the housing 100 together with the metal section 110 and the insulating section 120. In some embodiments, the metal conductive member 130 has a shape matching the insulating section 120, such as cylindrical or other shapes, to form a smooth transition with the insulating section 120 in the axial direction of the housing 100. The inner chamber of the metal conductive member 130 forms the mounting chamber together with the chambers of the metal section 110 and the insulating section 120.

In addition, please refer to FIGS. 2-5, in some embodiments, the metal conductive member 130 may be screwed into the cavity of the insulating section 120 and fixed by screwing the external thread of the metal conductive member 130 with the internal thread of the cavity of the insulating section 120. In some embodiments, the metal conductive member 130 and the extension portion 220 may also be fixed in other ways, such as welding, snapping, etc.

Please refer to FIGS. 2-5, in some embodiments, the rear end of the metal conductive member 130 may also be provided with a rear cover 140, and the rear cover 140 is fixed on the metal conductive member 130, for example, fixed by screwing the threaded hole of the rear cover 140 with the protruding threaded portion 132 on the metal conductive member 130. In some embodiments, the metal conductive member 130 and the rear cover 140 may also be fixed in other ways, such as welding, snapping, etc.

Further, please refer to FIG. 6, in some embodiments, the charging wire layer 2213 is located between the antenna layer (such as the first antenna layer 2211) and the first detection unit wire layer 2214. Or, in other embodiments, the charging wire layer 2213 may also be located between the antenna layer (such as the second antenna layer 2216) and the second detection unit wire layer 2215. The charging connection end 2263 is electrically connected to the charging wire 2233 through the fifth conductive hole 2255.

Further, please refer to FIG. 6, in some embodiments, the substrate layer 221 adjacent to the antenna layer is a clearance layer 2212, and the clearance layer 2212 is not provided with the antenna 222 and the onboard conductive wire 223 to ensure sufficient spatial distance between the substrate layer 221 where the onboard conductive wire 223 is located and the first antenna layer 2211 in the stacking direction. In some embodiments, the number of the clearance layer 2212 is not limited to one layer; in other embodiments, the clearance layer 2212 may also be two or more layers.

In some embodiments, the first antenna layer 2211, clearance layer 2212, charging wire layer 2213, first detection unit wire layer 2214, second detection unit wire layer 2215, and second antenna layer 2216 may also be set in other stacking ways, not limited to the stacking order shown in FIG. 6.

Further, please refer to FIGS. 1-5, in some embodiments, the housing 100 has a safety zone mark 101, the area from the front end of the housing 100 to the safety zone mark 101 is the safety zone, and the food temperature detection unit 400 is defined within the range of the safety zone. In some embodiments, the safety zone mark 101 may be a line or a concave-convex three-dimensional engraved line with a color obviously different from the surface of other areas of the housing 100, configured to indicate to the user the depth of insertion of the temperature measurement device 1 into the measured object (for example, food). Since the range of the safety zone is designed to allow full insertion into the food during use, and the temperature in the food is lower than the external cooking temperature, it may avoid damage to the electronic components of the temperature measurement device 1 by high temperatures in the cooking environment (for example, in an oven above 200°C., in a BBQ grill above 500° C., etc.). In addition, the safety zone mark 101 may also avoid damage to the housing 100 due to the temperature measurement device 1 entering the measured object too deeply and avoid burns to the operator, etc. In some embodiments, the safety zone mark 101 may be set on the outer wall of the housing 100. In some embodiments, the safety zone mark 101 may be set around the outer wall of the housing 100.

In some embodiments, the battery may be a rechargeable battery or adefinable battery. The battery is defined in the housing 100, and the battery is located within the range of the safety zone. The battery is configured to supply power to each electrical component in the temperature measurement device 1.

Please refer to FIGS. 1-5, in some embodiments, the control circuit board 200 is located within the range of the safety zone, in the longitudinal direction of the housing 100. The battery is located at the front end of the control circuit board 200.

Further, please refer to FIGS. 1-5, in some embodiments, to well obtain the signal of the antenna 222, the antenna 222 is defined on the rear side of the safety zone mark 101, that is, during the use of the temperature measurement device 1, the antenna 222 is outside the food to avoid the food affecting the signal transmission and reception of the antenna 222. In some embodiments, the ambient temperature detection unit 300 is defined on the rear side of the safety zone mark 101, that is, during the use of the temperature measurement device 1, the ambient temperature detection unit 300 is outside the food to well detect the temperature of the cooking environment. In some embodiments, the metal conductive member 130 is defined after the safety zone mark 101 to prevent repeated insertion into the food from damaging the metal conductive member 130. The charging connection end 2263 is also defined on the rear side of the safety line to facilitate docking with the metal conductive member 130.

Further, please refer to FIGS. 1-5, in some embodiments, the safety zone mark 101 is located on the metal section 110, that is, in this embodiment, part of the metal section 110 as well as the insulating section 120 and the metal conductive member 130 are located on the rear side of the safety zone mark 101. The antenna 222 is located in the insulating section 120 to ensure the communication effect of the antenna 222.

During the use of the temperature measurement device 1, the area of the device located on the rear side of the safety zone mark 101 is usually placed in a higher temperature. The extension portion 220 is also located on the rear side of the safety zone mark 101. Since structures such as the antenna 222, onboard conductive wire 223, and conductive vias on the extension portion 220 are merely conductive surfaces set on the substrate layer 221, they deform little under the high temperature of the cooking environment, thus ensuring stable electrical connection effects.

On the other hand, in addition to being applied to the above temperature measurement device 1, in other embodiments, the above control circuit board 200 may also be applied to other temperature measurement devices 1 that need to achieve wireless communication, especially temperature measurement devices 1 that need to be configured at high temperatures.

During the operation of the temperature measurement device 1, to make the signal of the antenna 222 relatively strong, a ground plane with a near loop may be constructed on the temperature measurement device 1 to improve the active power of the antenna signal.

In some embodiments, the lateral dimension of the extension portion 220 is smaller than the lateral dimension of the main portion 210. The insulating section 120 may be sleeved on the rear end of the metal section 110, which makes the space at the rear end of the metal section 110 relatively narrow. Therefore, in design, the lateral dimension of the extension portion 220 is made smaller than the lateral dimension of the main portion 210, so that the extension portion 220 may extend into the accommodation cavity formed by the insulating section 120, and at the same time, glue may be applied at the sleeve joint between the insulating section 120 and the metal section 110 to further make the connection between the two stable and have a waterproof effect. In some embodiments, due to the structural limitations of the temperature measurement device 1 itself, the construction of a near loop ground plane is limited. Therefore, how to design a ground feed point for the antenna to greatly improve the performance of the entire antenna is a problem.

In some embodiments, the main portion 210 is defined in the mounting chamber formed by the metal section 110, and the main portion 210 of the control circuit board 200 near the extension portion 220 is also provided with a ground feed point 600, the ground feed point 600 being electrically connected to the antenna signal processing unit 2111, and the ground feed point 600 being in abutting connection with the metal section 110 through a metal contact 601. By setting the ground feed point 600 at the main portion 210 near the extension portion 220, the ground feed point 600 is electrically connected to the antenna signal processing unit 2111 on one hand, and on the other hand, it is in abutting connection through the metal section 110, thereby constructing a ground signal close to the antenna 222.

In some embodiments, the first impedance matching structure 2241 extends forward to the ground feed point 600 of the main portion 210, so that the first impedance matching structure 2241 is electrically connected to the ground feed point 600.

In some embodiments, the main portion 210 of the control circuit board 200 near the extension portion 220 is provided with two ground conductive vias 602 to form the ground feed point 600. In some embodiments, please refer to FIG. 15, the metal contact 601 includes an elastic member 6011, the two ends of the elastic member 6011 being respectively connected to the two ground conductive vias 602, and forming an arch shape to be in abutting connection with the metal section 110. It may be understood that the elastic member 6011 is made of metal material and may conduct electricity. In some embodiments, the elastic member 6011 is a spring. FIG. 15 is a schematic diagram of a radial cross-section of the temperature measurement device.

In some embodiments, the metal contact 601 includes a spring, the two ends of the spring being respectively connected to the two ground conductive vias 602 and in contact with the metal section 110. By adding the metal contact 601 near the antenna 222, the antenna signal strength may be increased. In some embodiments, the metal contact 601 may also be configured for charging.

When specifically designing the control circuit board 200, it may be designed as one layer or multiple layers according to needs, for example, designed as six layers, that is, the substrate layers have six layers.

In some embodiments, the first layer may be the first antenna layer 2211. In some embodiments, the substrate layer adjacent to the antenna layer is a clearance layer, and in some embodiments, the clearance layer has two layers. For example, in the case where the first layer is the first antenna layer 2211, the second layer and the third layer are both clearance layers, and the clearance layers are substrate layers not provided with antennas and onboard conductive wires.

In some embodiments, one layer may be set as a complete ground plane, for example, the fourth layer among the substrate layers is set as a complete ground plane. It may be understood that, in such examples, the ground feed point 600 is electrically connected to the complete ground plane of the fourth layer, for example, through the ground conductive vias 602.

In some embodiments, the complete ground plane is electrically connected to the first impedance matching structure 2241 through the second conductive via 2242.

In some of the above embodiments, an antenna with a dipole structure is constructed, and a ground plane is constructed near the antenna signal feed point, providing a loop, thereby making the signal attenuation very small.

In some embodiments, the distance between the first impedance matching structure 2241 and the conductive wire 2221 is 5 mil.

In some embodiments, the width of the conductive wire 2221 is 17 mil.

In some of the above embodiments, through experimental testing, it may improve the active power of signals such as Bluetooth antenna signals by about 1.3 dB.

In some of the above embodiments, through experimental testing, the signal transmission attenuation is minimal, and at 8 dB transmit power, it may output at near full power.

This application has been described with reference to various exemplary embodiments. However, those skilled in the art will recognize that changes and modifications may be made to the exemplary embodiments without departing from the scope of this application. For example, various operational steps and components for performing the operational steps may be implemented in different ways depending on the specific application or considering any number of cost functions associated with the operation of the system (for example, one or more steps may be deleted, modified, or incorporated into other steps).

Although the principles of this application have been shown in various embodiments, many modifications of structures, arrangements, proportions, elements, materials, and components particularly suitable for specific environments and operational requirements may be configured without departing from the principles and scope of this disclosure. The above modifications and other changes or corrections will be included within the scope of this application.

The foregoing specific description has been described with reference to various embodiments. However, those skilled in the art will recognize that various corrections and changes may be made without departing from the scope of this disclosure. Therefore, the consideration of this disclosure will be illustrative rather than restrictive, and all these modifications will be included within its scope. Similarly, the advantages, other advantages, and solutions to problems of various embodiments have been as above. However, benefits, advantages, solutions to problems, and any elements that may produce these, or make them more explicit, should not be interpreted as critical, necessary, or essential. The term “including” configured in this application and any other variants thereof are non-exclusive inclusions, so that processes, methods, applications, or devices including a list of elements include not only these elements but also other elements not explicitly listed or not belonging to the process, method, system, application, or device. In addition, the term “coupling” configured in this application and any other variants thereof refer to physical connection, electrical connection, magnetic connection, optical connection, communication connection, functional connection, and/or any other connection.

Those with skill in the art will recognize that many changes may be made to the details of the above embodiments without departing from the basic principles of this application. Therefore, the scope of this application should be determined according to the following claims.

1. A temperature measurement device for food, comprising:
a housing, the housing comprising a front end that is capable of be inserted into the food and a rear end opposite to the front end, the housing forming a mounting chamber; the housing comprising a metal section and an insulating section, the insulating section is located behind the metal section;
a control circuit board, the control circuit board is defined in the mounting chamber; the control circuit board comprising a main portion and an extension portion extending rearward from the main portion, the main portion is defined in the mounting chamber formed by the metal section, the main portion comprising a control circuit, the control circuit comprising an antenna signal processing unit; the extension portion comprising at least one layer or multiple layers of stacked and fixed substrate layers, the extension portion is provided with an antenna, the antenna is electrically connected to the antenna signal processing unit through a conductive wire; the main portion of the control circuit board near the extension portion is also provided with a ground feed point, the ground feed point being electrically connected to the antenna signal processing unit, the ground feed point is in abutting connection with the metal section through a metal contact.

2. The temperature measurement device according to claim 1, wherein a substrate layer provided with the antenna is an antenna layer, and in a stacking direction of the substrate layers, the antenna layer is located at the outermost side.

3. The temperature measurement device according to claim 2, wherein the substrate layers are at least two layers, and in the stacking direction of the substrate layers, the two substrate layers located at the outermost sides are both the antenna layers, and the antennas on the two antenna layers are electrically connected to each other.

4. The temperature measurement device according to claim 3, wherein one antenna layer is a first antenna layer, and the other antenna layer is a second antenna layer; on the first antenna layer, its antenna is electrically connected to the antenna signal processing unit through the conductive wire.

5. The temperature measurement device according to claim 4, wherein the first antenna layer is provided with a first impedance matching structure, the first impedance matching structure is defined on two sides of the conductive wire;
the first impedance matching structure extends forward to the ground feed point of the main portion, so that the first impedance matching structure is electrically connected to the ground feed point.

6. The temperature measurement device according to claim 5, wherein a distance between the first impedance matching structure and the conductive wire is 5 mil.

7. The temperature measurement device according to claim 1, wherein a width of the conductive wire is 17 mil.

8. The temperature measurement device according to claim 1, wherein the main portion of the control circuit board near the extension portion is provided with two ground conductive vias to form the ground feed point.

9. The temperature measurement device according to claim 8, wherein the metal contact comprises an elastic member, two ends of the elastic member are respectively connected to the two ground conductive vias, and forming an arch shape to be in abutting connection with the metal section.

10. (canceled)

11. (canceled)

12. The temperature measurement device according to claim 1, wherein the substrate layers comprise six layers.

13. The temperature measurement device according to claim 12, wherein the first antenna layer is adjacent to two clearance layers.

14. The temperature measurement device according to claim 12, wherein the first antenna layer is the first layer, and the fourth layer among the substrate layers is set as a complete ground plane.

15. (canceled)

16. The temperature measurement device according to claim 4, wherein the second antenna layer is provided with a second impedance matching structure, the second impedance matching structure corresponding in position to the first impedance matching structure, and being electrically connected to the first impedance matching structure through a second conductive via.

17. The temperature measurement device according to claim 1, further comprising an ambient temperature detection unit, the ambient temperature detection unit is defined on the housing for detecting a temperature of cooking environment of the food;
wherein the extension portion is also provided with an onboard conductive wire, the antenna and the onboard conductive wire are respectively defined on different substrate layers, the onboard conductive wire is configured to electrically connect the control circuit to the ambient temperature detection unit.

18. The temperature measurement device according to claim 17, wherein the substrate layers are at least three layers, and in a stacking direction of the substrate layers, two substrate layers located at the outermost sides are both antenna layers, and antennas on the two antenna layers are electrically connected to each other;
the substrate layer provided with the onboard conductive wire is located between the two antenna layers.

19. The temperature measurement device according to claim 17, wherein the control circuit board near the extension portion is provided with two conductive vias to form the ground feed point.

20. The temperature measurement device according to claim 19, wherein the onboard conductive wire has a detection unit positive wire and a detection unit negative wire, the first detection unit wire and the second detection unit wire electrically connecting the ambient temperature detection unit to the control unit, a substrate layer where the first detection unit wire and the second detection unit wire located are located inside the antenna layer, the antenna layer comprising a first contact and a second contact for electrically connecting the ambient temperature detection unit, the first contact is electrically connected to the detection unit positive wire, the second contact is electrically connected to the detection unit negative wire.

21. (canceled)

22. The temperature measurement device according to claim 17, wherein the onboard conductive wire comprises a charging wire, the control circuit comprises a charging circuit, the charging wire is electrically connected to the charging circuit; a substrate layer provided with the charging wire is a charging wire layer, the charging wire layer is located inside the antenna layer, the antenna layer comprising a charging contact, the charging contact is electrically connected to the charging wire.

23. (canceled)

24. (canceled)

25. The temperature measurement device according to claim 1, wherein the substrate layer adjacent to the antenna layer is a clearance layer.

26. (canceled)

27. The temperature measurement device according to claim 1, wherein a lateral dimension of the extension portion is smaller than a lateral dimension of the main portion.
